(19) United States
(12) Patent Application Publication
(10) Pub. No.: US 2026/0179996 A1
(43) Pub. Date: Jun. 25, 2026

(54) LAMINATION APPARATUS, ELECTRODE LAMINATE BODY MANUFACTURING LINE, AND ELECTRODE LAMINATE BODY MANUFACTURING METHOD

(71) Applicant: HONDA MOTOR CO., LTD., Tokyo (JP)

(72) Inventor: Shota Ishikawa, Wako-shi (JP)

(21) Appl. No.: 19/419,178

(22) Filed: Dec. 15, 2025

(30) Foreign Application Priority Data
Dec. 25, 2024 (JP) 2024-228845

(51) Int. Cl. H01M 10/04; H01M 4/04

(52) U.S. Cl. CPC H01M 10/0404; H01M 4/0435

(57) ABSTRACT

A lamination apparatus of an embodiment is arranged on a downstream of a transportation apparatus which transports a plurality of electrode bodies and laminates the plurality of electrode bodies, the apparatus including: a placement plate that laminates the plurality of electrode bodies transported by the transportation apparatus; a wall portion provided to stand on the placement plate and provided at a position facing a transportation direction of the electrode bodies; and a press portion that presses side surfaces of the plurality of electrode bodies laminated on the placement plate to a wall portion side, wherein the wall portion performs a correction arrangement of the electrode bodies, and the press portion has a rotation section that has a cylindrical shape and rotates, when the rotation section comes into contact with a side surface of an electrode body transported by the transportation apparatus, in a side surface direction of the electrode body.

### CROSS-REFERENCE TO RELATED APPLICATION

Priority is claimed on Japanese Patent Application No. 2024-228845, filed on Dec. 25, 2024, the contents of which are incorporated herein by reference.

### BACKGROUND

### Field of the Invention

The present invention relates to a lamination apparatus, an electrode laminate body manufacturing line, and an electrode laminate body manufacturing method.

### Background

In recent years, in order to ensure that more people have access to affordable, reliable, sustainable, and advanced energy, research and development relating to a secondary battery, which contributes to energy efficiency, has been conducted.

A laminate cell and a laminate square cell that are used as a secondary battery have a structure in which a plurality of electrode bodies are laminated and accommodated in a laminate film or a cell can. Accordingly, a step of manufacturing these battery cells includes a step of laminating a plurality of electrode bodies.

For example, PCT International Publication No. WO 2013/125219 discloses a technique of laminating a positive electrode sheet, a negative electrode sheet, a separator, and the like by an operation of a pivoting unit having an arm.

### SUMMARY

However, in the conventional technique disclosed in PCT International Publication No. WO 2013/125219, since the arm grips and laminates the positive electrode sheet, the negative electrode sheet, the separator, and the like one by one, it may take time to complete the lamination, and there is room for improvement.

An aspect of the present invention provides a lamination apparatus, an electrode laminate body manufacturing line and an electrode laminate body manufacturing method that shorten the time for lamination of a plurality of electrode bodies. This aspect of the present invention further contributes to energy efficiency.

A first aspect of the present invention is a lamination apparatus that is arranged on a downstream of a transportation apparatus which transports a plurality of electrode bodies and laminates the plurality of electrode bodies, the lamination apparatus including: a placement plate that laminates the plurality of electrode bodies transported by the transportation apparatus; a wall portion that is provided to stand on the placement plate and is provided at a position facing a transportation direction of the electrode bodies; and a press portion that presses side surfaces of the plurality of electrode bodies laminated on the placement plate to a side of the wall portion, wherein the wall portion performs a correction arrangement of the electrode bodies, and the press portion has a rotation section that has a cylindrical shape and rotates, when the rotation section comes into contact with a side surface of an electrode body transported by the transportation apparatus among the plurality of electrode bodies, in a side surface direction of the electrode body.

According to the first aspect described above, since the lamination can be performed by utilizing the motion of the transported electrode body itself, it is possible to shorten the time for completion of the lamination. Further, the transported electrode body comes into contact with the wall portion and is pressed to the side of the wall portion by the rotation section of the press portion, and therefore, displacement of the electrode body is prevented.

A second aspect is the lamination apparatus according to the first aspect, wherein the rotation section may rotate in the side surface direction of the electrode body and thereby draw and laminate the electrode body onto the plurality of electrode bodies laminated on the placement plate.

According to the second aspect described above, the plurality of electrode bodies can be laminated and aligned.

A third aspect is the lamination apparatus according to the first or second aspect, wherein the press portion may have a mechanism that separates the rotation section from the wall portion in association with the plurality of electrode bodies being laminated.

According to the third aspect described above, even if the lamination number of electrode bodies is increased, the plurality of electrode bodies can be laminated and aligned while maintaining a state in which the electrode body is pressed to the side of the wall portion by the rotation section.

A fourth aspect is the lamination apparatus according to any one of the first to third aspects which may include: a detection portion that detects a lamination number of the electrode bodies, wherein a distance to the rotation section from a surface of the wall portion with which the electrode body comes into contact may be lengthened in a perpendicular direction of the surface of the wall portion with which the electrode body comes into contact in accordance with the lamination number of the electrode bodies based on a detection result of the detection portion.

According to the fourth aspect described above, even if the lamination number of electrode bodies is increased, the plurality of electrode bodies can be laminated and aligned while maintaining a state in which the electrode body is pressed to the side of the wall portion by the rotation section.

A fifth aspect is the lamination apparatus according to the fourth aspect, wherein a distance to the rotation section from the surface of the wall portion with which the electrode body comes into contact may be equal to or less than 200 mm.

According to the fifth aspect described above, even if the lamination number of electrode bodies is increased, the plurality of electrode bodies can be laminated and aligned while maintaining a state in which the electrode body is pressed to the side of the wall portion by the rotation section.

A sixth aspect is the lamination apparatus according to any one of the first to fifth aspects, wherein the wall portion may have a recess section that is recessed in a thickness direction of the wall portion from a base end which is the surface of the wall portion with which the electrode body comes into contact.

According to the sixth aspect described above, even when the plurality of electrode bodies are laminated so as to be in contact with a side surface of the wall portion, by inserting a member having a plate shape into the recess section and pressing the plurality of electrode bodies in a direction which is away from the side surface of the wall portion by the member, it is possible to recover the plurality of electrode bodies while maintaining a state in which the plurality of electrode bodies are laminated.

A seventh aspect is the lamination apparatus according to the sixth aspect which may include: a restraint tool that restrains the electrode body in the recess section.

According to the seventh aspect described above, the plurality of electrode bodies can be restrained by the restraint tool in a state where the plurality of electrode bodies are laminated so as to be in contact with the side surface of the wall portion.

An eighth aspect is the lamination apparatus according to any one of the first to seventh aspects, wherein the electrode body may include a first negative electrode layer, a first solid electrolyte layer, a positive electrode layer, a second solid electrolyte layer, and a second negative electrode layer, and the electrode body may have a current collector in which an end portion in a lamination direction of the first negative electrode layer, the positive electrode layer, and the second negative electrode layer is constituted of copper.

According to the eighth aspect described above, since the electrode body does not include a liquid or a gel but includes a solid electrolyte layer, it is possible to lower the possibility that the electrode body is damaged when the electrode body collides with the wall portion.

A ninth aspect is an electrode laminate body manufacturing line that transports a plurality of electrode bodies and laminates the plurality of electrode bodies at a downstream in a transportation direction, the electrode laminate body manufacturing line including: a transportation apparatus that transports the plurality of electrode bodies; and the lamination apparatus according to any one of the first to eighth aspects, wherein a plurality of lamination apparatuses each of which is the lamination apparatus are provided, and when a predetermined number of electrode bodies among the plurality of electrode bodies are laminated in one lamination apparatus among the plurality of lamination apparatuses, the electrode laminate body manufacturing line laminates an electrode body among the plurality of electrode bodies in another lamination apparatus among the plurality of lamination apparatuses.

According to the ninth aspect described above, the electrode body can be continuously laminated, and the time for completion of the lamination can be shortened.

A tenth aspect is an electrode laminate body manufacturing method of transporting a plurality of electrode bodies and laminating the plurality of electrode bodies at a downstream in a transportation direction, the electrode laminate body manufacturing method including: laminating the plurality of electrode bodies that are transported; and correcting a lamination state of the plurality of electrode bodies.

According to the tenth aspect described above, the electrode body can be continuously laminated, and the time for completion of the lamination can be shortened.

According to the aspect of the present invention, it is possible to provide a lamination apparatus, an electrode laminate body manufacturing line, and an electrode laminate body manufacturing method that shorten the time for lamination of a plurality of electrode bodies.

### BRIEF DESCRIPTION OF THE DRAWINGS

FIG. 1 is a schematic view showing an electrode laminate body manufacturing line according to an embodiment of the present invention.

FIG. 2 is a plan view showing a first example of a lamination apparatus (stocker) according to an embodiment of the present invention, wherein (a) of FIG. 2 is a view showing a state before laminating electrode bodies, and (b) of FIG. 2 is a view showing a state in which electrode bodies are laminated.

FIG. 3 is a plan view showing a second example of a lamination apparatus (stocker) according to an embodiment of the present invention, wherein (a) of FIG. 3 is a view showing a state before laminating electrode bodies, and (b) of FIG. 3 is a view showing a state in which electrode bodies are laminated.

FIG. 4 is a plan view showing a third example of a lamination apparatus (stocker) according to an embodiment of the present invention, wherein (a) of FIG. 4 is a view showing a state before laminating electrode bodies, and (b) of FIG. 4 is a view showing a state in which electrode bodies are laminated.

FIG. 5 is a perspective view showing a laminate cell manufactured in an electrode body manufacturing line according to an embodiment of the present invention.

### DESCRIPTION OF EMBODIMENTS

Hereinafter, embodiments of the present invention will be described in detail with reference to the drawings.

### Electrode Laminate Body Manufacturing Line, Lamination Apparatus

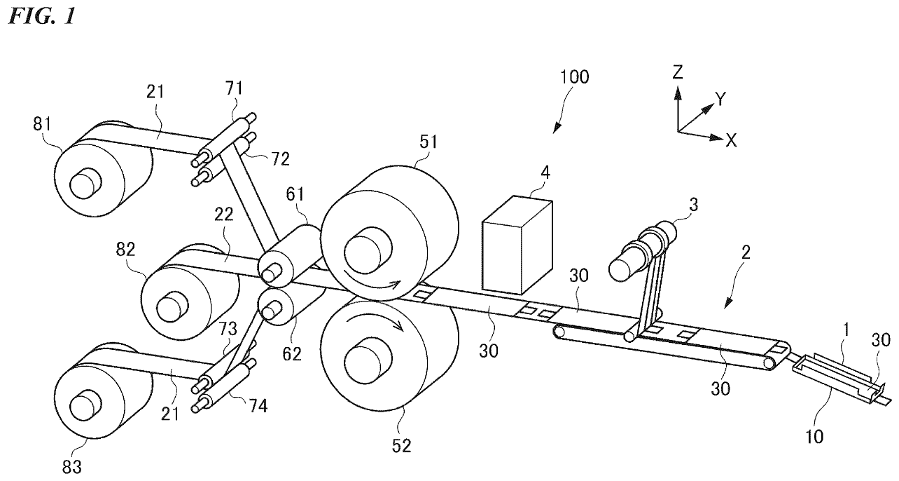

FIG. 1 is a schematic view showing an electrode laminate body manufacturing line according to an embodiment of the present invention.

As shown in FIG. 1, an electrode laminate body manufacturing line 100 of the present embodiment includes a transportation apparatus 2 that transports a plurality of electrode bodies 30 and a lamination apparatus (stocker) 1 that is arranged on a downstream of the transportation apparatus 2 and laminates the plurality of electrode bodies 30.

Electrode rolls 81 and 83 around which a negative-electrode electrode member 21 is wound and an electrode roll 82 around which a positive-electrode electrode member 22 is wound are provided on the transportation apparatus 2. The positive-electrode electrode member 22 includes a current collector and a positive electrode active material applied to the current collector. The negative-electrode electrode member 21 includes a current collector and a negative electrode active material applied to the current collector. A battery cell in the present embodiment is a solid state battery, and the positive-electrode electrode member 22 (positive electrode layer) is arranged between a pair of negative-electrode electrode members 21 (negative electrode layer). A solid electrolyte layer is arranged between the positive-electrode electrode member (positive electrode layer) and the negative-electrode electrode member (negative electrode layer). In the electrode laminate body manufacturing line 100, the solid electrolyte layer may be provided on both surfaces of the positive-electrode electrode member 22 or may be provided on one surface of the negative-electrode electrode member 21. In the present specification, a structure in which the positive-electrode electrode member 22 is arranged between the negative-electrode electrode members 21 is referred to as the electrode body 30.

In a later step, a tab lead is joined to each of positive-electrode and negative-electrode current collectors, and the plurality of electrode bodies 30 are covered by a laminate film in a state where the tab lead is exposed.

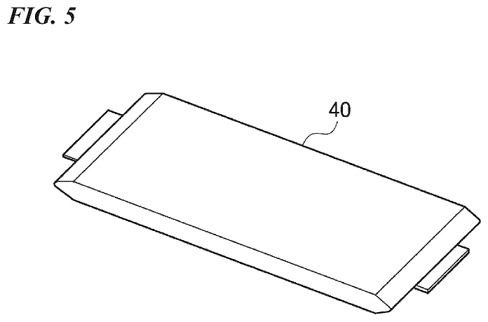

FIG. 5 is a perspective view showing a laminate cell 40 using the electrode body 30 manufactured in the electrode laminate body manufacturing line 100.

A transportation direction of the electrode body 30 in the present embodiment coincides with a long axis direction of the electrode body 30. The electrode member 21 of a negative-electrode electrode roll 81 is guided by roll devices 71 and 72 and is overlapped with other electrode members by roll devices 61 and 62. The electrode member 22 of the positive electrode roll 82 is guided by the roll devices 61 and 62 and is overlapped with other electrode members. The electrode member 21 of the negative electrode roll 83 is guided by roll devices 73 and 74 and is overlapped with other electrode members by the roll devices 61 and 62.

The three electrode members that are overlapped by the roll devices 61 and 62 are pressed from above and below by roll presses 51 and 52 and are integrated. Next, a laser cutter 4 provided above a transportation path emits a laser and makes a cut in an edge material of an outer circumferential portion of the integrated electrode body 30. For example, when the electrode body 30 is transported to the transportation apparatus 2, which is a conveyer belt, the edge material in which the cut is made is wound by an edge material winding device 3.

The transportation apparatus 2 transports the electrode body 30 at a predetermined speed (for example, 1 meters per second). The electrode body 30 transported to an end of the transportation apparatus 2 flies out of the transportation apparatus 2 by inertia and falls onto the lamination apparatus 1. The electrode body 30 transported from the transportation apparatus 2 is sequentially laminated on the lamination apparatus 1. The lamination apparatus 1 is arranged at a downstream of the transportation apparatus 2 at a position close to the transportation apparatus 2 (that is, a position where the electrode body 30 transported from the transportation apparatus 2 can be received).

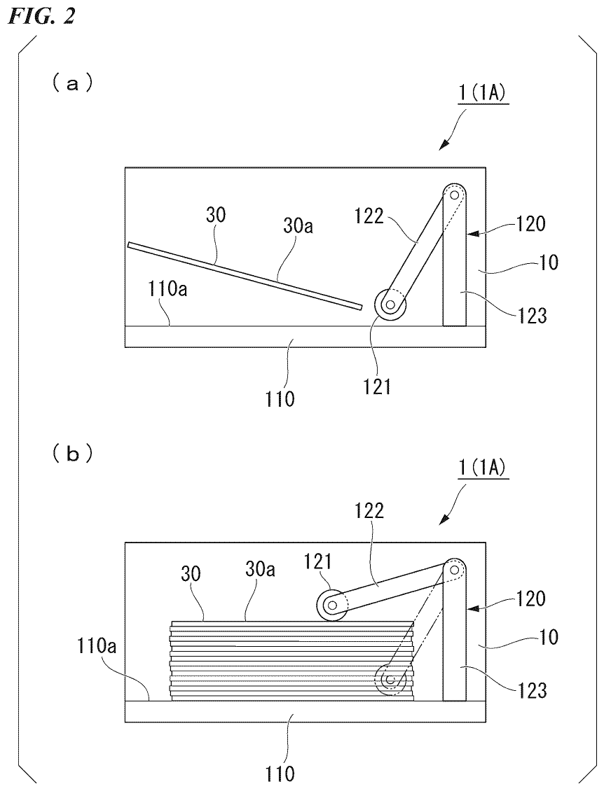

FIG. 2 is a plan view showing a first example of a lamination apparatus (stocker) according to an embodiment of the present invention, wherein (a) of FIG. 2 is a view showing a state before laminating electrode bodies, and (b) of FIG. 2 is a view showing a state in which electrode bodies are laminated.

The lamination apparatus 1 in the first example is referred to as a lamination apparatus 1A. The lamination apparatus 1A has a placement plate 10 on which a plurality of electrode bodies 30 transported by the transportation apparatus 2 are laminated. The placement plate 10 has a wall portion 110 and a press portion 120. The wall portion 110 is provided to stand on the placement plate 10 along a transportation direction. The press portion 120 is provided to stand at one end side of the wall portion 110 in the transportation direction on a surface (side surface) 110a of the wall portion 110 with which the electrode body 30 comes into contact. The press portion 120 has a rotation section 121 that has a cylindrical shape and rotates, when the rotation section 121 comes into contact with a side surface 30a of the electrode body 30 transported by the transportation apparatus 2, in a side surface 30a direction of the electrode body 30.

The wall portion 110 is a surface facing the electrode body 30 in a Y-axis direction which is a direction orthogonal to the transportation direction.

The placement plate 10 of the lamination apparatus 1 is inclined downward toward a downstream side from an upstream side in the transportation direction (X-axis direction), that is, as the placement plate 10 is away from the transportation apparatus 2. Accordingly, the electrode body 30 transported to the lamination apparatus 1 moves downward toward the press portion 120 and stops by coming into contact with the rotation section 121 of the press portion 120. Further, the placement plate 10 of the lamination apparatus 1 is inclined downward as the placement plate 10 is away from the transportation apparatus 2 in the orthogonal direction (Y-axis direction) orthogonal to the transportation direction. Accordingly, the electrode body 30 transported to the lamination apparatus 1 moves downward along the wall portion 110, comes into contact with the rotation section 121 of the press portion 120, and stops by being pressed to the side surface 110a side of the wall portion 110 by the rotation section 121. That is, the wall portion 110 performs a correction arrangement that corrects a position of the electrode body 30 to the lamination apparatus 1.

Thereby, the plurality of electrode bodies 30 that are continuously transported from the transportation apparatus 2 are laminated and aligned in a state of being in contact with the wall portion 110 and the rotation section 121 of the press portion 120.

The rotation section 121 rotates in the side surface 30a direction of the electrode body 30 and thereby draws and laminates the electrode body 30, as shown in FIG. 2, onto the plurality of electrode bodies 30 laminated on the placement plate 10.

Thereby, the plurality of electrode bodies 30 are laminated and aligned.

The press portion 120 has a mechanism that separates the rotation section 121 from the wall portion 110, as shown in FIG. 2, as the plurality of electrode bodies 30 are laminated. In the first example, as shown in FIG. 2, as the mechanism that separates the rotation section 121 from the wall portion 110, the press portion 120 has an arm section 122 that rotatably holds the rotation section 121 and a support section 123 that is provided to stand on the side surface 110a of the wall portion 110 and supports the arm section 122 such that the arm section 122 is movable in a direction away from the side surface 110a of the wall portion 110. Thereby, even if the lamination number of electrode bodies 30 is increased, the plurality of electrode bodies 30 can be laminated and aligned while maintaining a state in which the electrode body 30 is pressed to the side surface 110a side of the wall portion 110 by the rotation section 121.

For example, when 100 electrode bodies are laminated, the thickness of each electrode is thin, but the height of the outermost surface varies by forming a cell. By providing a movable section of the press portion such that the variation in the height direction can be absorbed, it becomes possible to align the end portions. Further, it also becomes possible to absorb an impact received when the electrode body 30 comes into contact with the press portion.

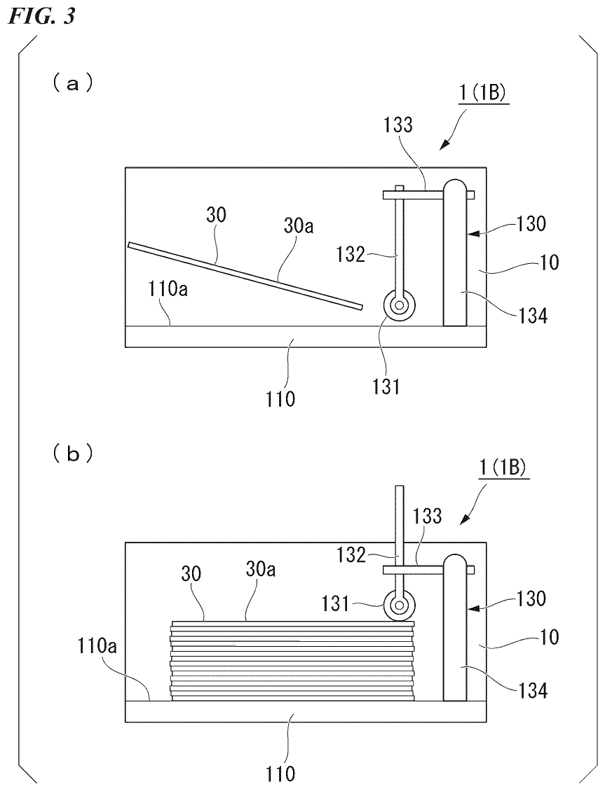

FIG. 3 is a plan view showing a second example of a lamination apparatus (stocker) according to an embodiment of the present invention, wherein (a) of FIG. 3 is a view showing a state before laminating electrode bodies, and (b) of FIG. 3 is a view showing a state in which electrode bodies are laminated. In FIG. 3, the same configurations as the configurations shown in FIG. 2 are denoted by the same reference numerals, and descriptions thereof are omitted.

The lamination apparatus 1 in the second example is referred to as a lamination apparatus 1B. In the lamination apparatus 1B, the placement plate 10 has a wall portion 110 and a press portion 130. The press portion 130 is provided to stand at one end side of the wall portion 110 in the transportation direction on the side surface 110a of the wall portion 110. The press portion 130 has a rotation section 131 that has a cylindrical shape and rotates, when the rotation section 131 comes into contact with the side surface 30a of the electrode body 30, in a side surface 30a direction of the electrode body 30. The rotation section 131 rotates in the side surface 30a direction of the electrode body 30 and thereby draws and laminates the electrode body 30, as shown in FIG. 3, onto the plurality of electrode bodies 30 laminated on the placement plate 10. Thereby, the plurality of electrode bodies 30 are laminated and aligned.

The press portion 130 has a mechanism that separates the rotation section 131 from the wall portion 110, as shown in FIG. 3, as the plurality of electrode bodies 30 are laminated. In the second example, as shown in FIG. 3, as the mechanism that separates the rotation section 131 from the wall portion 110, the press portion 130 has an arm section 132 that rotatably holds the rotation section 131, a first support section 133 that supports the arm section 132 such that the arm section 132 is movable in a direction away from the side surface 110a of the wall portion 110, and a second support section 134 that supports the first support section 133 and is provided to stand on the side surface 110a of the wall portion 110. Thereby, even if the lamination number of electrode bodies 30 is increased, the plurality of electrode bodies 30 can be laminated and aligned while maintaining a state in which the electrode body 30 is pressed to the side surface 110a side of the wall portion 110 by the rotation section 131.

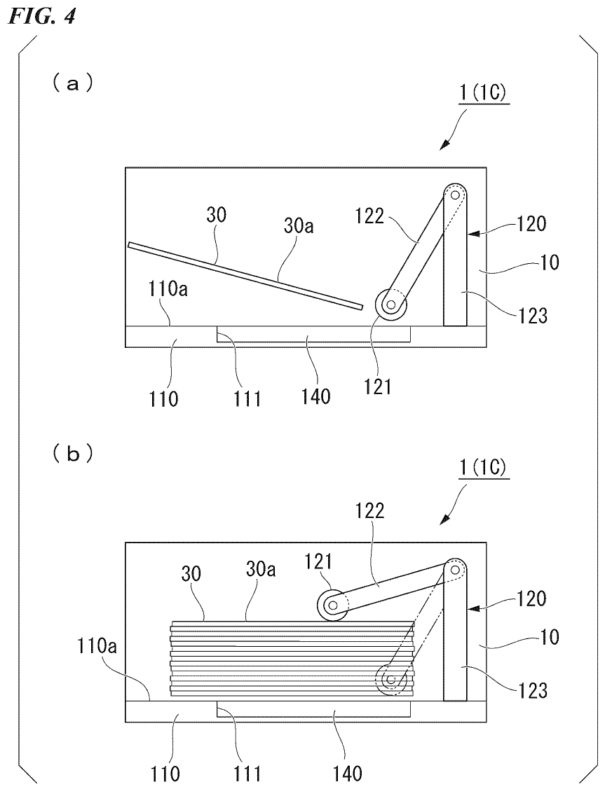

FIG. 4 is a plan view showing a third example of a lamination apparatus (stocker) according to an embodiment of the present invention, wherein (a) of FIG. 4 is a view showing a state before laminating electrode bodies, and (b) of FIG. 4 is a view showing a state in which electrode bodies are laminated. In FIG. 4, the same configurations as the configurations shown in FIG. 2 are denoted by the same reference numerals, and descriptions thereof are omitted.

The lamination apparatus 1 in the third example is referred to as a lamination apparatus 1C. In the lamination apparatus 1C, in addition to the configurations of the lamination apparatus 1A, the wall portion 110 has a recess section 111 that is recessed in a thickness direction of the wall portion 110 from a base end which is the side surface 110a of the wall portion 110. Thereby, even when the plurality of electrode bodies 30 are laminated so as to be in contact with the side surface 110a of the wall portion 110, by inserting a member having a plate shape into the recess section 111 and pressing the plurality of electrode bodies 30 in a direction which is away from the side surface 110a of the wall portion 110 by the member, it is possible to recover the plurality of electrode bodies 30 while maintaining a state in which the plurality of electrode bodies 30 are laminated.

The lamination apparatus 1C can preferably include a restraint tool 140 that restrains the electrode body 30 in the recess section 111. Thereby, the plurality of electrode bodies 30 can be restrained by the restraint tool 140 in a state where the plurality of electrode bodies 30 are laminated so as to be in contact with the side surface 110a of the wall portion 110. Consequently, the plurality of electrode bodies 30 can be laminated and aligned.

The lamination apparatus 1 can preferably include a detection portion (not shown) that detects a lamination number of the electrode bodies 30. The lamination apparatus 1 lengthens a distance to the rotation section 121, 131 described above from the side surface 110a of the wall portion 110 in a perpendicular direction of the side surface 110a of the wall portion 110 in accordance with the lamination number of the electrode bodies 30 on the basis of a detection result of the detection portion. Thereby, even if the lamination number of electrode bodies 30 is increased, the plurality of electrode bodies 30 can be laminated and aligned while maintaining a state in which the electrode body 30 is pressed to the side surface 110a side of the wall portion 110 by the rotation section 131.

The distance from the side surface 110a of the wall portion 110 to the rotation section 121,131 described above can be preferably equal to or less than 200 mm. When the distance is equal to or less than 200 mm, even if the lamination number of electrode bodies 30 is increased, the plurality of electrode bodies 30 can be laminated and aligned while maintaining a state in which the electrode body 30 is pressed to the side surface 110a side of the wall portion 110 by the rotation section 131.

The electrode body 30 includes a first negative electrode layer, a first solid electrolyte layer, a positive electrode layer, a second solid electrolyte layer, and a second negative electrode layer. The electrode body 30 has a current collector in which an end portion in a lamination direction of the first negative electrode layer, the positive electrode layer, and the second negative electrode layer is constituted of copper.

### Positive Electrode Layer

The positive electrode layer is constituted by laminating a first current collector and a positive electrode material layer including at least a positive electrode active material.

The first current collector can be preferably constituted of at least one material having a high conductivity. An end portion of the first current collector is constituted of copper.

Examples of the material having a high conductivity include a metal or an alloy containing at least one of metal elements such as silver (Ag), palladium (Pd), gold (Au), platinum (Pt), aluminum (Al), chromium (Cr), and nickel (Ni), or a non-metal such as carbon (C). In consideration of manufacturing costs in addition to the high conductivity, aluminum, nickel, or stainless steel can be preferably used. Further, aluminum is unlikely to react with the positive electrode active material and an electrolyte. Therefore, when aluminum is used for the first current collector, the internal resistance of the battery can be reduced.

Examples of forms of the first current collector can include a foil form, a plate form, a mesh form, a non-woven fabric form, a foam form, and the like. Further, in order to enhance adhesion to a positive electrode active material layer, carbon or the like may be arranged on a surface of the first current collector, or the surface may be coarsened.

The positive electrode active material layer includes a positive electrode active material that exchanges lithium ions and electrons. The positive electrode active material is not particularly limited as long as the positive electrode active material is a material capable of reversibly releasing and absorbing lithium ions and transferring electrons, and a known positive electrode active material that is applicable to a positive electrode of a lithium-ion battery can be used. Examples of the positive electrode active material include composite oxides such as lithium cobalt oxide (LiCoO₂), lithium nickel oxide (LiNiO₂), lithium manganese oxide (LiMn₂O₄), solid solution oxides (Li₂MnO₃—LiMO₂ (M═Co, Ni, or the like)), lithium-manganese-nickel-cobalt oxide (LiNiₓMn_{y}Co_{z}O₂, x+y+z=1), and olivine-type lithium phosphate oxide (LiFePO₄); conductive polymers such as polyaniline and polypyrrole; sulfides such as Li₂S, CuS, Li—Cu—S compounds, TiS₂, FeS, MoS₂, and Li—Mo—S compounds; and mixtures of sulfur and carbon. The positive electrode active material may be constituted of one kind of the above materials alone or may be constituted of two or more kinds thereof.

The positive electrode active material layer includes an electrolyte that exchanges lithium ions with the positive electrode active material. The electrolyte is not particularly limited as long as the electrolyte has lithium-ion conductivity, and a material generally used for a lithium-ion battery can be used. Examples of the electrolyte can include inorganic solid electrolytes such as sulfide solid electrolyte materials, oxide solid electrolyte materials, halide solid electrolytes, and lithium-containing salts, polymer-based solid electrolytes such as polyethylene oxide, gel-based solid electrolytes containing lithium-containing salts or lithium-ion conductive ionic liquids, and the like.

Among these, sulfide solid electrolyte materials can be preferably used from the viewpoint of high conductivity properties of lithium ions, favorable structural formability by pressing, and favorable interfacial bonding properties.

The electrolyte may be constituted of one kind of the above materials alone or may be constituted of two or more kinds thereof.

The electrolyte included in the first active material layer may be the same material as or may be a material different from the electrolyte included in a second active material layer and the solid electrolyte layer.

From the viewpoint of improvement in conductivity of the positive electrode, the positive electrode active material layer may also contain a conductive additive. A conductive additive which can be generally used for a lithium-ion battery can be used as the conductive additive.

Examples of the conductive additive can include carbon black such as acetylene black or Ketjen black; carbon fibers; vapor grown carbon fibers; graphite powder; and carbon materials such as carbon nanotubes. The conductive additive may be constituted of one kind of the above materials alone or may be constituted of two or more kinds thereof.

Further, the positive electrode active material layer may contain a binder that plays a role in binding the positive electrode active materials to each other, and the positive electrode active material and the first current collector to each other.

The first current collector is assembled at one end portion in a width direction of the electrode body 30.

The positive electrode active material layer is in contact with the solid electrolyte layer and may therefore contain sulfides contained in the solid electrolyte layer.

### First Negative Electrode Layer, Second Negative Electrode Layer

The first negative electrode layer and the second negative electrode layer are constituted by laminating a second current collector and a negative electrode active material layer including at least a negative electrode active material.

The second current collector contains at least copper (Cu). Similarly to the first current collector, the second current collector may contain a material other than copper having a high conductivity. Examples of the material other than copper having a high conductivity include a metal or an alloy containing at least one of metal elements such as silver (Ag), palladium (Pd), gold (Au), platinum (Pt), chromium (Cr), and nickel (Ni), or a non-metal such as carbon (C). In consideration of manufacturing costs in addition to the high conductivity, nickel or stainless steel can be preferably used as the material other than copper. Further, stainless steel is unlikely to react with the positive electrode active material, the negative electrode active material, and the electrolyte. Therefore, when stainless steel is used for a second current collector foil, the manufacturing costs of the battery can be reduced.

Examples of forms of the second current collector can include a foil form, a plate form, a mesh form, a non-woven fabric form, a foam form, and the like. Further, in order to enhance adhesion to the second active material layer, carbon or the like may be arranged on a surface of the second current collector, or the surface may be coarsened.

The negative electrode active material layer includes the negative electrode active material that exchanges lithium ions and electrons. The negative electrode active material is not particularly limited as long as the negative electrode active material is a material capable of reversibly releasing and absorbing lithium ions and transferring electrons, and a known negative electrode active material that is applicable to a negative electrode of a lithium-ion battery can be used. Examples of the negative electrode active material include carbonaceous materials such as natural graphite, artificial graphite, resin charcoal, carbon fibers, activated charcoal, hard carbon, and soft carbon; alloy-based materials mainly consisting of tin, a tin alloy, silicon, a silicon alloy, gallium, a gallium alloy, indium, an indium alloy, aluminum, an aluminum alloy, and the like; conductive polymers such as polyacene, polyacetylene, and polypyrrole; metallic lithium; and lithium alloys such as lithium-titanium composite oxides (for example, Li₄Ti₅O₁₂). These negative electrode active materials may be constituted of one kind of the above materials alone or may be constituted of two or more kinds thereof.

The negative electrode active material layer includes an electrolyte that exchanges lithium ions with the negative electrode active material. The electrolyte is not particularly limited as long as the electrolyte has lithium-ion conductivity, and a material generally used for a lithium-ion battery can be used. Examples of the electrolyte can include inorganic solid electrolytes such as sulfide solid electrolyte materials, oxide solid electrolyte materials, halide solid electrolytes, and lithium-containing salts, polymer-based solid electrolytes such as polyethylene oxide, gel-based solid electrolytes containing lithium-containing salts or lithium-ion conductive ionic liquids, and the like. The electrolyte may be constituted of one kind of the above materials alone or may be constituted of two or more kinds thereof.

The electrolyte included in the second active material layer may be similar to or different from the electrolyte included in the first active material layer and the solid electrolyte layer.

The negative electrode active material layer may contain a conductive additive, a binder, and the like. These materials are not particularly limited, but, for example, materials similar to those used for the positive electrode active material layer described above can be used.

### First Solid Electrolyte Layer, Second Solid Electrolyte Layer

The first solid electrolyte layer and the second solid electrolyte layer are arranged between the positive electrode active material layer and the negative electrode active material layer.

The electrolyte is not particularly limited as long as the electrolyte has lithium-ion conductivity and insulation properties, and a material generally used for a lithium-ion battery can be used. Examples of the electrolyte can include inorganic solid electrolytes such as sulfide solid electrolyte materials, oxide solid electrolyte materials, halide solid electrolytes, and lithium-containing salts, polymer-based solid electrolytes such as polyethylene oxide, gel-based electrolytes containing lithium-containing salts or lithium-ion conductive ionic liquids, and the like. Among these, sulfide solid electrolyte materials can be preferably used from the viewpoint of high conductivity properties of lithium ions, favorable structural formability by pressing, and favorable interfacial bonding properties.

The form of the electrolyte materials is not particularly limited, but examples of the form can include a form of particles.

The first solid electrolyte layer and the second solid electrolyte layer may contain an adhesive for imparting mechanical strength and flexibility.

The first solid electrolyte layer and the second solid electrolyte layer may have a sheet shape having a porous substrate and a solid electrolyte held in the porous substrate. The form of the porous substrate described above is not particularly limited, but examples of the form include woven fabric, non-woven fabric, mesh cloth, a porous film, an expanded sheet, a punching sheet, and the like. Among these forms, non-woven fabric can be preferably used from the viewpoint of handleability in which the filling amount of a solid electrolyte cam be enhanced.

The porous substrate described above can be preferably constituted of an insulating material. Thereby, insulation properties of the first solid electrolyte layer and the second solid electrolyte can be improved. Examples of the insulating material include resin materials such as nylon, polyester, polyethylene, polypropylene, polytetrafluoroethylene, an ethylene-tetrafluoroethylene copolymer, polyvinylidene fluoride, polyvinylidene chloride, polyvinyl chloride, polyurethane, vinylon, polybenzimidazole, polyimide, polyphenylene sulfite, polyether ether ketone, cellulose, and an acrylic resin; natural fibers such as hemp, wood pulp, and cotton lint; glass; and the like.

According to the lamination apparatus 1 of the present embodiment, since the lamination can be performed by utilizing the motion of the transported electrode body itself, it is possible to shorten the time for completion of the lamination. Further, the transported electrode body comes into contact with the wall portion and is pressed to the wall portion side by the rotation section of the press portion, and therefore, displacement of the electrode body is prevented. Further, in the electrode laminate body manufacturing line 100 of the present embodiment, a plurality of lamination apparatuses 1 may be provided. When the plurality of lamination apparatuses 1 are provided, when a predetermined number of electrode bodies 30 are laminated in one lamination apparatus 1, the electrode bodies 30 are laminated in another lamination apparatus 1.

According to the electrode laminate body manufacturing line 100 of the present embodiment, the electrode body can be continuously laminated, and the time for completion of the lamination can be shortened.

### Electrode Laminate Body Manufacturing Method

An electrode laminate body manufacturing method according to the embodiment of the present invention is an electrode laminate body manufacturing method of transporting a plurality of electrode bodies and laminating the plurality of electrode bodies at a downstream in a transportation direction, the electrode laminate body manufacturing method has: a step (hereinafter, referred to as a “first step”) of laminating the plurality of electrode bodies that are transported; and a step (hereinafter, referred to as a “second step”) of correcting a lamination state of the plurality of electrode bodies.

In the electrode laminate body manufacturing method of the present embodiment, for example, the electrode laminate body manufacturing line 100 of the embodiment described above is used.

In the first step, the plurality of electrode bodies 30 that are transported at a predetermined speed by the transportation apparatus 2 are laminated by the lamination apparatus 1.

In the second step, for example, by using the lamination apparatus 1A, the plurality of electrode bodies 30 that are continuously transported from the transportation apparatus 2 are moved downward along the wall portion 110, and the electrode bodies 30 are pressed to the side surface 110a side of the wall portion 110 by the rotation section 121 of the press portion 120. Thereby, the plurality of electrode bodies 30 are laminated and aligned in a state of being in contact with the wall portion 110 and the rotation section 121 of the press portion 120.

According to the electrode laminate body manufacturing method of the present embodiment, the electrode body can be continuously laminated, and the time for completion of the lamination can be shortened.

Although embodiments of the present invention have been described in detail, the present invention is not limited to the embodiments described above, and various modifications and changes can be made within the scope of the gist of present invention described in the claims.

What is claimed is:

1. A lamination apparatus that is arranged on a downstream of a transportation apparatus which transports a plurality of electrode bodies and laminates the plurality of electrode bodies, the lamination apparatus comprising:
a placement plate that laminates the plurality of electrode bodies transported by the transportation apparatus;
a wall portion that is provided to stand on the placement plate and is provided at a position facing a transportation direction of the electrode bodies; and
a press portion that presses side surfaces of the plurality of electrode bodies laminated on the placement plate to a side of the wall portion,
wherein the wall portion performs a correction arrangement of the electrode bodies, and
the press portion has a rotation section that has a cylindrical shape and rotates, when the rotation section comes into contact with a side surface of an electrode body transported by the transportation apparatus among the plurality of electrode bodies, in a side surface direction of the electrode body.

2. The lamination apparatus according to claim 1,
wherein the rotation section rotates in the side surface direction of the electrode body and thereby draw and laminate the electrode body onto the plurality of electrode bodies laminated on the placement plate.

3. The lamination apparatus according to claim 1,
wherein the press portion has a mechanism that separates the rotation section from the wall portion in association with the plurality of electrode bodies being laminated.

4. The lamination apparatus according to claim 1, comprising:
a detection portion that detects a lamination number of the electrode bodies,
wherein a distance to the rotation section from a surface of the wall portion with which the electrode body comes into contact is lengthened in a perpendicular direction of the surface of the wall portion with which the electrode body comes into contact in accordance with the lamination number of the electrode bodies based on a detection result of the detection portion.

5. The lamination apparatus according to claim 4,
wherein a distance to the rotation section from the surface of the wall portion with which the electrode body comes into contact is equal to or less than 200 mm.

6. The lamination apparatus according to claim 1,
wherein the wall portion has a recess section that is recessed in a thickness direction of the wall portion from a base end which is the surface of the wall portion with which the electrode body comes into contact.

7. The lamination apparatus according to claim 6, comprising:
a restraint tool that restrains the electrode body in the recess section.

8. The lamination apparatus according to claim 1,
wherein the electrode body includes a first negative electrode layer, a first solid electrolyte layer, a positive electrode layer, a second solid electrolyte layer, and a second negative electrode layer, and
the electrode body has a current collector in which an end portion in a lamination direction of the first negative electrode layer, the positive electrode layer, and the second negative electrode layer is constituted of copper.

9. An electrode laminate body manufacturing line that transports a plurality of electrode bodies and laminates the plurality of electrode bodies at a downstream in a transportation direction, the electrode laminate body manufacturing line comprising:
a transportation apparatus that transports the plurality of electrode bodies; and
the lamination apparatus according to claim 1,
wherein a plurality of lamination apparatuses each of which is the lamination apparatus are provided, and
when a predetermined number of electrode bodies among the plurality of electrode bodies are laminated in one lamination apparatus among the plurality of lamination apparatuses, the electrode laminate body manufacturing line laminates an electrode body among the plurality of electrode bodies in another lamination apparatus among the plurality of lamination apparatuses.

10. An electrode laminate body manufacturing method of transporting a plurality of electrode bodies and laminating the plurality of electrode bodies at a downstream in a transportation direction, the electrode laminate body manufacturing method comprising:
laminating the plurality of electrode bodies that are transported; and
correcting a lamination state of the plurality of electrode bodies.
